(19) United States
(12) Patent Application Publication
(10) Pub. No.: US 2007/0206665 A1
(43) Pub. Date: Sep. 6, 2007

(54) Apparatus and method for code tracking loop in a CDMA system

(75) Inventor: Sang-Yun Hwang, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/701,095

(22) Filed: Feb. 1, 2007

(30) Foreign Application Priority Data
Feb. 1, 2006 (KR) 9872/2006

(51) Int. Cl. H04B 1/00

(52) U.S. Cl. 375/148

(57) ABSTRACT

A code tracking loop apparatus and method for improving a reception capability of a rake receiver in a CDMA system. The code tracking loop apparatus includes an on-time signal block for outputting a first signal, which is obtained by eliminating an interference signal of an adjacent path from an on-time integral value for a received signal of a predetermined path; an early-time signal block for eliminating an interference signal of an adjacent path from an early-time integral value for the received signal of the predetermined path, and then multiplying the interference-eliminated signal by a conjugate complex of the first signal; a late-time signal block for eliminating an interference signal of an adjacent path from a late-time integral value for the received signal of the predetermined path, and then multiplying the interference-eliminated signal by a conjugate complex of the first signal; and a first subtractor for calculating a difference between an output of the early-time signal block and an output of the late-time signal block.

### PRIORITY

This application claims the benefit under 35 U.S.C. §119(a) of an application filed in the Korean Industrial Property Office on Feb. 1, 2006 and assigned Serial No. 2006-9872, the contents of which are incorporated herein by reference.

### BACKGROUND OF THE INVENTION

1. Field of the Invention

The present invention relates to a rake receiver in a Code Division Multiple Access (CDMA) system, and more particularly to an apparatus and method for code tracking loop in a rake receiver in a Direct Sequence-Code Division Multiple Access (DS-CDMA) system.

2. Description of the Related Art

In general, a DS-CDMA system uses a rake receiver that receives channel signals with diversity by using the delay spread of the channel signals. The rake receiver includes a searcher, a plurality of fingers, and a combiner. The searcher determines whether the same signals received after being delayed through multiple paths are signals having a predetermined threshold value. When the determination by the searcher concludes that a path has effective energy, the path is allocated to each finger. Each finger performs data demodulation through measurement of channel and measurement of time error and frequency error for the allocated path. The data demodulated by each finger is summed by the combiner and is then decoded by a channel decoder located after the combiner.

The code tracking loop of the DS-CDMA communication system functions to more precisely set rough timing found by the searcher. Because the actual paths found by the searcher have different initial time error values, each of the paths must independently perform the time calibration. If the current received data is defined by Equation (1) below, the time error value of a non-coherent code tracking loop for the k^{th} path is expressed by Equation (2) below.

$$\begin{matrix}y ( t ) = {\sum }_{l = 0}^{L - 1} {a}_{l} \cdot s ( t - {T}_{l} ) + n ( t ) & ( 1 ) \\ {E}_{k} ( t ) = {{v}_{E , k} ( t )}^{2} - {{v}_{L , k} ( t )}^{2} & ( 2 )\end{matrix}$$

In Equation (2), ν_{E,k=1} and ν_{L,k=1} denote integral values of early-time and late-time for the k^{th} path of the multiple paths, respectively, which are defined by Equations (3) and (4) below.

$$\begin{matrix}\begin{matrix}{v}_{ E , k} ( t ) = ID \{ y ( t ) \times s ( t - {T}_{ k} + {τ}_{ e , k} + \frac{ {T}_{ c}}{ 2} ) \} \\ = {\sum }_{l = 0}^{L - 1} {a}_{l} \cdot g ( {τ}_{e , k} - ( {T}_{k} - {T}_{l} ) + \frac{{T}_{c}}{2} ) + {n}_{E , k} ( t )\end{matrix} & ( 3 ) \\ \begin{matrix}{v}_{ L , k} ( t ) = ID \{ y ( t ) \times s ( t - {T}_{ k} + {τ}_{ e , k} + \frac{ {T}_{ c}}{ 2} ) \} \\ = {\sum }_{l = 0}^{L - 1} {a}_{l} \cdot g ( {τ}_{e , k} - ( {T}_{k} - {T}_{l} ) + \frac{{T}_{c}}{2} ) + {n}_{L , k} ( t )\end{matrix} & ( 4 )\end{matrix}$$

In Equations (3) and (4), τ_{e,k} denotes a time error value in the k^{th} path, and T_{c} denotes a chip period. ID(·) denote a de-spreader (integrator) having a particular integration interval, and may have a different time error value for each path. n_{E,k}(t) and n_{L,k}(t) denote noise elements generated in the integration of the early-time and the late-time, respectively, and g(t) denotes an autocorrelation value of s(t), which implies a pulse-shaping signal of a received signal. g(t) has a maximum value at the position where t=0, and is defined by Equation (5) below in the case of a raise cosine pulse-shaping signal.

$$g ( t ) = \frac{sin ( π \cdot t )}{π \cdot t} \cdot \frac{cos ( RollOff \cdot π \cdot t )}{1 - {( 2 \cdot RollOff \cdot t )}^{2}} \qquad ( 5 )$$

The time error value of Equation (2) is calibrated by increasing τ_{e,k} when the time error has a positive value, or by reducing τ_{e,k} when the time error has a negative value.

A coherent code tracking apparatus used in a DS-CDMA communication system calculates the time error value by using the difference between the early-time integral value and the late-time integral value as noted from Equation (2). If each path has an interval of T_{c}, a correlation characteristic by another path also remains to cause an incorrect time error, when the integration of the early-time and late-time is performed. For example, when L=3, the integral values of the early-time and late-time for the second path (k=1) are defined by Equations (6) and (7) below.

$$\begin{matrix}{v}_{E , k = 1} ( t ) = {a}_{0} \cdot g ( {τ}_{e , k = 1} - \frac{{T}_{c}}{2} ) + {a}_{1} \cdot g ( {τ}_{e , k = 1} + \frac{{T}_{c}}{2} ) + {a}_{2} \cdot g ( {τ}_{e , k = 1} + \frac{3 {T}_{c}}{2} ) + {n}_{E , k = 1} ( t ) & ( 6 ) \\ {v}_{L , k = 1} ( t ) = {a}_{0} \cdot g ( {τ}_{e , k = 1} + \frac{3 {T}_{c}}{2} ) + {a}_{1} \cdot g ( {τ}_{e , k = 1} - \frac{{T}_{c}}{2} ) + {a}_{2} \cdot g ( {τ}_{e , k = 1} + \frac{{T}_{c}}{2} ) + {n}_{L , k = 1} ( t ) & ( 7 )\end{matrix}$$

As noted from Equations (6) and (7), in the case of the second path (k=1), correlation values for the first path and the third path exist in the early-time and late-time integral values. Actually, in the case of early-time integration, a large correlation value for the first path exists as noted from the first item of ν_{E,k=1} in Equation (6). In contrast, in the case of late-time integration, a large correlation value for the third path exists as noted from the third item of ν_{L.k=1} in Equation (7). Therefore, if there is an adjacent path having a strong energy, the time error calibration for a particular path results in failure and convergence to the path having strong energy occurs according to the passage of time, in view of the characteristics of the code tracking loop. However, in a DS-CDMA system, the more numerous the dividable paths, the higher the reception capability can be improved. Therefore, the calibration failure and convergence as described above degrades the capability of a receiver.

In order to prevent such capability degradation, a code tracking loop employing interference-eliminating technology has been proposed. According to this method, an adjacent path is estimated and is then regenerated, and a corresponding element thereof is then eliminated from the received signal. For example, when L=3, a time error value for the second path is calculated by using a value obtained by subtracting the regenerated first and third path signals from a received signal as noted from Equation (8) below.
y(t)′=y(t)−{ν_{O,k=0}(t)·s(t+τ_{e,k=0})+ν_{O,k=2}(t)·s(t−2T_{c}+τ_{e,k=2})} (8)

In Equation (8), ν_{O,k=0} denotes an on-time integral value for the k^{th} path, which is defined by Equation (9) below. If the time difference between the paths is T_{c}, an early-time integral value and a late-time integral value for the second path are defined by Equations (10) and (11) below, respectively, when the interference-eliminating technology is applied.

$$\begin{matrix}{v}_{ O , k} ( t ) = ID \{ y ( t ) \times s ( t - {T}_{k} + {τ}_{e , k} ) \} \\ = {\sum }_{l = 0}^{L - 1} {a}_{l} \cdot g ( {τ}_{e , k} - ( {T}_{k} - {T}_{l} ) ) + {n}_{O , k} ( t )\end{matrix} \qquad ( 9 )$$

In Equation (9), n_{O,k}(t) denotes a noise item of the on-time integral value.

$$\begin{matrix}{{v}_{E , k = 1} ( t )}^{′} = \{ \underbrace{{a}_{0} \cdot g ( {τ}_{e , k = 1} - \frac{{T}_{c}}{2} )}_{B} - \underbrace{{v}_{O , k = 0} ( t ) \cdot g ( \underbrace{{τ}_{e , k = 1} - \frac{{T}_{c}}{2}}_{a} - \underbrace{{τ}_{e , k = 0}}_{b} )}_{A} \} + {a}_{1} \cdot g ( {τ}_{e , k = 1} + \frac{{T}_{c}}{2} ) + \{ \underbrace{{a}_{2} \cdot g ( {τ}_{e , k = 1} + \frac{3 {T}_{c}}{2} )}_{B} - \underbrace{{v}_{O , k = 2} ( t ) \cdot g ( \underbrace{{τ}_{e , k = 1} - \frac{{T}_{c}}{2}}_{a} - \underbrace{( {τ}_{e , k = 2} - 2 {T}_{c} )}_{b} )}_{A} \} + {n}_{E , k = 1} ( t ) & ( 10 ) \\ {{v}_{L , k = 1} ( t )}^{′} = \{ \underbrace{{a}_{0} \cdot g ( {τ}_{e , k = 1} - \frac{3 {T}_{c}}{2} )}_{B} - \underbrace{{v}_{O , k = 0} ( t ) \cdot g ( \underbrace{{τ}_{e , k = 1} - \frac{3 {T}_{c}}{2}}_{a} - \underbrace{{τ}_{e , k = 0}}_{b} )}_{A} \} + {a}_{1} \cdot g ( {τ}_{e , k = 1} - \frac{{T}_{c}}{2} ) + \{ \underbrace{{a}_{2} \cdot g ( {τ}_{e , k = 1} + \frac{{T}_{c}}{2} )}_{B} - \underbrace{{v}_{O , k = 2} ( t ) \cdot g ( \underbrace{{τ}_{e , k = 1} - \frac{3 {T}_{c}}{2}}_{a} - \underbrace{( {τ}_{e , k = 2} - 2 {T}_{c} )}_{b} )}_{A} \} + {n}_{L , k = 1} ( t ) & ( 11 )\end{matrix}$$

In Equations (10) and (11), items “A” can be obtained in a simple and easy manner by using on-time integral values ν_{O,k=0}(t), ν_{O,k=2}(t) of other paths and, information on difference between early-time, late-time integral timing values “a” and timing values “b” of other paths. That is to say, those items can be easily obtained by using the on-time integral values and the items “a” and “b” of Equation (11) after obtaining a table of g(ΔT) according to ΔT in advance.

FIG. 1 shows a conventional code tracking loop apparatus as described above, which is implemented by universalizing Equations (9), (10), and (11). The first “A” item and the second “A” item in Equation (10) are implemented by the multipliers designated by 117 and 119 in FIG. 1, and the first “A” item and the second “A” item in Equation (11) are implemented by the multipliers 127 and 129 in FIG. 1. The result of Equation (10) is the same as the output of the subtractor 115, and the result of Equation (11) is the same as the output of the subtractor 125. The output signal of the adder 105 can be expressed by Equation (9).

In the case of non-coherent code tracking loop using the interference-eliminating technology as described above, ideal interference elimination is impossible as long as exact timing has not been set for each path, that is, if ν_{O,k} and τ_{E,k} do not have exact “αₖ” and “0,” respectively. This is because, when there is time error for each path, there is difference between the “A” items and the “B” items to be eliminated in Equations (10) and (11), which causes limitation in improvement of the capability.

That is, the rake receiver applying the diversity technology using the delay spread as described above has a big problem in its operation when the delay spread is smaller than a predetermined threshold.

### SUMMARY OF THE INVENTION

Accordingly, the present invention has been made to solve the above-mentioned problems occurring in the prior art, and an aspect of the present invention is to provide a code tracking loop apparatus and method for improving a reception capability of a rake receiver in a Code Division Multiple Access (CDMA) system.

It is another aspect of the present invention to provide a code tracking loop apparatus and method, which can reduce capability degradation, which may occur when there is small time delay between paths for the same signal, in a rake receiver in a CDMA system.

In accordance with the above aspect, there is provided a code tracking loop apparatus in a rake receiver for calibrating a time error of each path by receiving a multi-layer signal in a Code Division Multiple Access (CDMA) system, the code tracking loop apparatus including an on-time signal block for outputting a first signal, which is obtained by eliminating an interference signal of an adjacent path from an on-time integral value for a received signal of a predetermined path; an early-time signal block for eliminating an interference signal of an adjacent path from an early-time integral value for the received signal of the predetermined path, and then multiplying the interference-eliminated signal by a conjugate complex of the first signal; a late-time signal block for eliminating an interference signal of an adjacent path from a late-time integral value for the received signal of the predetermined path, and then multiplying the interference-eliminated signal by a conjugate complex of the first signal; and a first subtractor for calculating a difference between an output of the early-time signal block and an output of the late-time signal block.

The on-time signal block includes an on-time accumulator for multiplying the received signal by an on-time signal and accumulating products of the multiplication by a predetermined integral period, thereby outputting an on-time integral value; a first multiplier for multiplying a delayed on-time integral value of a previous path by a pulse-shaping filter coefficient corresponding to a timing difference between the previous path and the on-time signal; a second multiplier for multiplying a delayed on-time integral value of a next path by a pulse-shaping filter coefficient corresponding to a timing difference between the next path and the on-time signal; and a second subtractor for subtracting output signals of the first and second multipliers from the on-time integral value of the on-time accumulator.

The early-time signal block includes an early-time accumulator for multiplying the received signal by an early-time signal and accumulating products of the multiplication by a predetermined integral period, thereby outputting an early-time integral value; a first multiplier for multiplying an on-time integral value of a previous path by a pulse-shaping filter coefficient corresponding to a timing difference between the previous path and the early-time signal; a second multiplier for multiplying an on-time integral value of a next path by a pulse-shaping filter coefficient corresponding to a timing difference between the next path and the early-time signal; and a second subtractor for subtracting output signals of the first and second multipliers from the early-time integral value of the early-time accumulator.

The late-time signal block includes a late-time accumulator for multiplying the received signal by a late-time signal and accumulating products of the multiplication by a predetermined integral period, thereby outputting a late-time integral value; a first multiplier for multiplying an on-time integral value of a previous path by a pulse-shaping filter coefficient corresponding to a timing difference between the previous path and the late-time signal; a second multiplier for multiplying an on-time integral value of a next path by a pulse-shaping filter coefficient corresponding to a timing difference between the next path and the late-time signal; and a second subtractor for subtracting output signals of the first and second multipliers from the late-time integral value of the late-time accumulator.

In accordance with another aspect of the present invention, there is provided a code tracking loop method in a rake receiver for calibrating a time error of each path by receiving a multi-layer signal in a Code Division Multiple Access (CDMA) system, the code tracking loop method including outputting a first signal, a second signal, and a third signal by eliminating an interference signal of an adjacent path from integral values of an on-time signal, an early-time signal, and a late-time signal for a received signal of a predetermined path, respectively; multiplying the second signal and the third signal by a conjugate complex of the first signal, respectively; and calculating a difference between a conjugate complex of the first signal and the multiplied signal.

The step of outputting the first signal includes multiplying the received signal by an on-time signal and accumulating products of the multiplication by a predetermined integral period, thereby outputting an on-time integral value; multiplying a delayed on-time integral value of a previous path by a pulse-shaping filter coefficient corresponding to a timing difference between the previous path and the on-time signal, thereby generating an interference signal; multiplying a delayed on-time integral value of a next path by a pulse-shaping filter coefficient corresponding to a timing difference between the next path and the on-time signal, thereby generating an interference signal; and subtracting the interference signals from the on-time integral value.

The step of outputting the second signal includes multiplying the received signal by an early-time signal and accumulating products of the multiplication by a predetermined integral period, thereby outputting an early-time integral value; multiplying an on-time integral value of a previous path by a pulse-shaping filter coefficient corresponding to a timing difference between the previous path and the early-time signal, thereby generating an interference signal; multiplying an on-time integral value of a next path by a pulse-shaping filter coefficient corresponding to a timing difference between the next path and the early-time signal, thereby generating an interference signal; and subtracting the interference signals from the early-time integral value.

The step of outputting the third signal includes multiplying the received signal by a late-time signal and accumulating products of the multiplication by a predetermined integral period, thereby outputting a late-time integral value; multiplying an on-time integral value of a previous path by a pulse-shaping filter coefficient corresponding to a timing difference between the previous path and the late-time signal, thereby generating an interference signal; multiplying an on-time integral value of a next path by a pulse-shaping filter coefficient corresponding to a timing difference between the next path and the late-time signal, thereby generating an interference signal; and subtracting the interference signals from the late-time integral value.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a conventional code tracking loop apparatus;

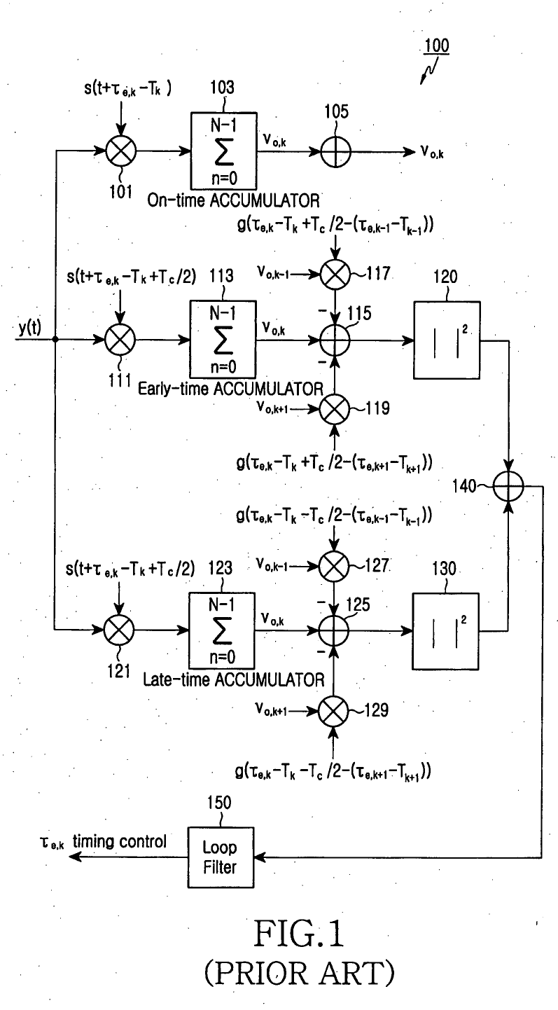

FIG. 2 illustrates a code tracking loop apparatus in a CDMA system according to the first embodiment of the present invention;

FIG. 3 illustrates a code tracking loop apparatus according to the second embodiment of the present invention; and

FIG. 4 is a graph illustrating comparison between the capability of a conventional code tracking loop and a code tracking loop according to the present invention.

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings. Further, various specific definitions found in the following description are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

The present invention provides a code tracking loop apparatus and method for improving a reception capability of a rake receiver in a Code Division Multiple Access (CDMA) system. Especially, the present invention provides a code tracking loop apparatus and method, which can reduce capability degradation, which may occur when there is small time delay between paths for the same signal, in a rake receiver in a CDMA system.

In the following description, code loop apparatuses according to the present invention will be first discussed, and code loop methods thereof will be then discussed.

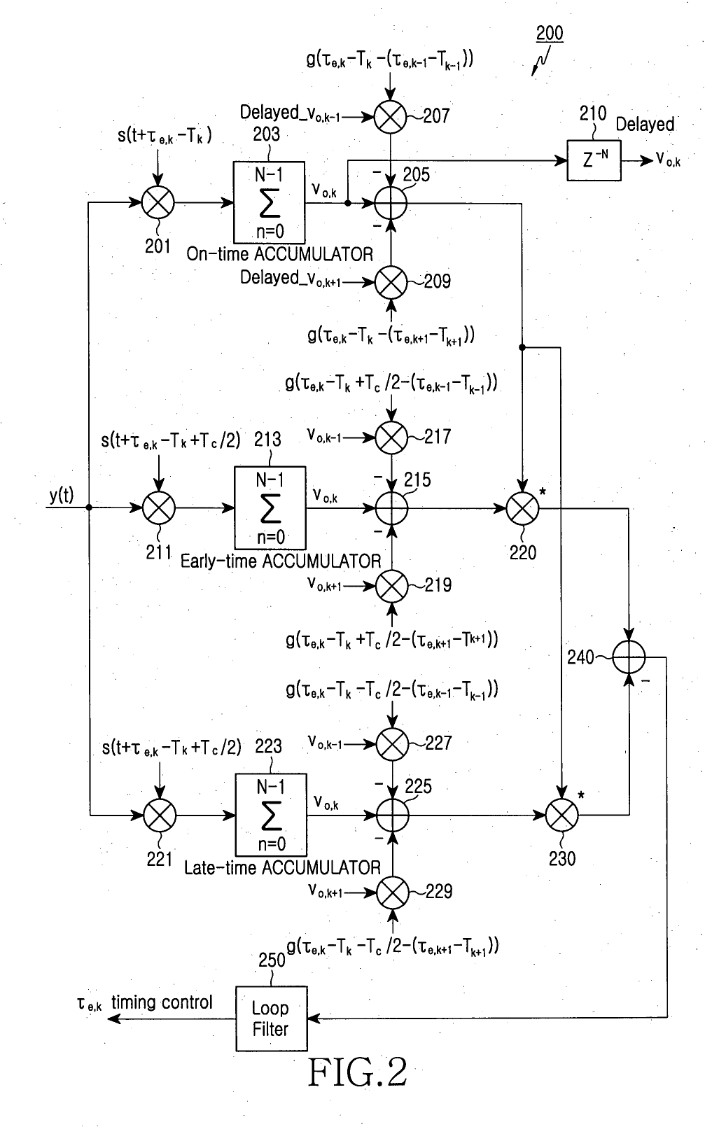

FIG. 2 shows an example of a code tracking loop apparatus in a CDMA system according to the present invention. In a code tracking loop method according to this example, an interference signal between adjacent paths is eliminated from an on-time signal, a conjugate complex number value of the interference-eliminated on-time signal is then multiplied by the early-time signal and the late-time signal, respectively, and a difference between products of the multiplication is used in the code tracking loop. In the following description, a description of the same elements as those of the prior art will be omitted.

Referring to FIG. 2, a code tracking loop apparatus 200 according to the present invention basically includes functional blocks for processing an on-time signal, an early-time signal, and a late-time signal. Further, the code tracking loop apparatus 200 includes at least two multipliers 220 and 230 for multiplying conjugate value of interference-eliminated on-time integral values by integral values obtained by eliminating interference from the early-time and late-time signals, and a subtractor 240 for obtaining a difference between outputs of the multipliers 220 and 230.

The functional blocks for processing the on-time signal include an accumulator 203 for multiplying the currently received signal by the on-time signal N times and accumulating the products of the N times of multiplication, two multipliers 207 and 209 for reproducing interference elements of adjacent paths in order to eliminate the interference signal elements by the adjacent paths, and an on-time subtractor 205 for eliminating the interference signal. In the process by these blocks, N times refers to the period of integration, which may change according to the system.

The on-time subtractor 205 subtracts the output values of the two multipliers 207 and 209 from the output value of the on-time accumulator 203. Reference numerals 207 and 209 indicate the first multiplier and the second multiplier, respectively.

The first multiplier 207 calculates Delayed_V_{O,k-1}, which is obtained by delaying an on-time integral value of a previous path by one integral period (N chips), and calculates a difference between an on-time integral value of a current path and the on-time integral value of the previous path, and then multiplies the Delayed_V_{O,k-1} by g(τ_{e,k}−Tₖ−(τ_{e,k-1}−Tₖ₋₁)), which is a coefficient of a pulse-shaping filter corresponding to the calculated difference. Further, the second multiplier 209 calculates Delayed_V_{O,k+1}, which is obtained by delaying an on-time integral value of a next path by one integral period (N chips), and calculates a difference between an on-time integral value of a current path and the on-time integral value of the next path, and then multiplies the Delayed_V_{O,k+1} by g(τ_{e,k}−Tₖ−(τ_{e,k+1}−Tₖ₊₁)), which is a coefficient of a pulse-shaping filter corresponding to the calculated difference.

The functional blocks for processing the early-time signal include an accumulator 213 for multiplying the currently received signal by the early-time signal N times (the integration period) and accumulating the products of the N times of multiplication, multipliers 217 and 219 for reproducing interference elements of adjacent paths by using the on-time signal of the previous path, and a subtractor 215 for eliminating the interference signal. These functional blocks receive the interference-eliminated on-time signal integral values from the functional blocks processing the on-time signal and perform conjugate multiplication of the received values.

The functional blocks for processing the late-time signal include an accumulator 223 for multiplying the currently received signal by the late-time signal N times (the integration period) and accumulating the products of the N times of multiplication, multipliers 227 and 229 for reproducing interference elements of adjacent paths by using the on-time signal of the previous path, and a subtractor 225 for eliminating the interference signal. These functional blocks receive the interference-eliminated on-time signal integral values from the functional blocks processing the on-time signal and perform conjugate multiplication of the received values.

The subtractor 240 calculates a difference between the signals of the early-time processing blocks and the late-time processing blocks, thereby obtaining a time error value.

The on-time integral value, which is an output signal of the on-time accumulator 203, is transferred to code tracking loops by a delayer 210 in order to eliminate interference signals. Hereinafter, a code tracking loop method according to the present invention using the code tracking loop apparatus 200 will be described.

The main idea of the present invention is to calculate the time error value Eₖ(t) by multiplying the delayed interference-eliminated on-time integral value by the early-time and late-time integral values, as shown by Equation (12) below.
Eₖ(t)=ν_{O,k}(t)′*·{ν_{E,k}(t)′−ν_{L,k}(t)′} (12)

In Equation (12), ν_{O,k}(t)′, ν_{E,k}(t)′, and ν_{L,k}(t)′ are defined by Equations (13), (14), and (15) below, respectively, and “*” implies a complex conjugate value of a signal.

$$\begin{matrix}{{v}_{O , k} ( t )}^{′} = ID \{ {y ( t )}^{″} \times s ( t - k \cdot {T}_{c} + {τ}_{e , k} ) \} & ( 13 ) \\ {{v}_{E , k} ( t )}^{′} = ID \{ {y ( t )}^{″} \times s ( t - k \cdot {T}_{c} + {τ}_{e , k} + \frac{{T}_{c}}{2} ) \} & ( 14 ) \\ {{v}_{L , k} ( t )}^{′} = ID \{ {y ( t )}^{″} \times s ( t - k \cdot {T}_{c} + {τ}_{e , k} - \frac{{T}_{c}}{2} ) \} & ( 15 )\end{matrix}$$

In the above Equations, y(t)′ and y(t)″ are defined by Equations (16) and (17) below.
y(t)′=y(t)−{ν_{O,k-1}(t)·s(t+τ_{e,k-1}−Tₖ₋₁)+ν_{O,k+1}(t)·s(t+τ_{e,k+1}−Tₖ₊₁)} (16)
y(t)″=y(t)−{Delayed_ν_{O,k-1}(t)·s(t+τ_{e k-1}−Tₖ₋₁)+Delayed_ν_{O,k+1}(t)·s(t+τ_{e,k+1}−Tₖ₊₁)} (17)

Equation (12) uses the interference-eliminated on-time integral value. This is because, when only the fading element αₖ for the path to be tracked remains in the on-time integral value, correlation values for other paths in the early-time integral value and the late-time integral value are eliminated through the process of Equation (12) and the process by the loop filter 250 for the time error value as shown in FIG. 2. As a result, it is possible to improve the capability of the code tracking loop. This characteristic is due to the fact that different fading elements αₖ have independent characteristics in the probability as noted from Equation (18).
E[a₁*·aₖ]_{l≠k}=0 (18)

In Equation (17), the Delayed_ν_{o,k-1}(t) and the Delayed_ν_{o,k+1}(t) corresponds to a value obtained by delaying the on-time integral value ν_{o,k-1}(t) and ν_{o,k-1}(t), respectively by the integral period. The reason why the Delayed_ν_{o,k-1}(t) and the Delayed_ν_{o,k+1}(t) is used is that, when the same the Delayed_ν_{o,k-1}(t) and the Delayed_ν_{o,k+1}(t) is used in order to eliminate adjacent path elements from the on-time, early-time, and late-time integral values, the noise element n_{o,k}(t) of Equation (9) becomes a square element by Equation (12). Such a square element of n_{o,k}(t) degrades the capability of the code tracking loop. For this reason, the present invention uses the delayed on-time integral value Delayed_ν_{o,k-1}(t) and Delayed_ν_{o,k+1}(t) in eliminating the adjacent path elements from the on-time integral value. Because the noise element of the ν_{o,k}(t) and the noise element of the Delayed_ν_{o,k}(t) are independent to each other in view of the probability, the capability of the code tracking loop is not degraded.

The on-time, early-time, and late-time integral values for the k^{th} path are defined by Equations (19), (20), and (21) below.

The on-time, early-time, and late-time integral values for the k^{th} path are defined by Equations (19), (20), and (21) below.

$$\begin{matrix}{{v}_{O , k} ( t )}^{′} = \{ \begin{matrix}{a}_{k - 1} \cdot g ( {τ}_{e , k} - ( {T}_{k} - {T}_{k - 1} ) ) - \\ \underbrace{{Delayed\_v}_{O , k - 1} ( t ) \cdot \underbrace{g ( {τ}_{e , k} - {T}_{k} - ( {τ}_{e , k - 1} - {T}_{k - 1} ) )}_{B 1}}_{A 1}\end{matrix} \} + {a}_{k} \cdot g ( {τ}_{e , k} ) + \{ \begin{matrix}{a}_{k + 1} \cdot g ( {τ}_{e , k} - ( {T}_{k} - {T}_{k + 1} ) ) - \\ \underbrace{{Delayed\_v}_{O , k + 1} ( t ) \cdot \underbrace{g ( {τ}_{e , k} - {T}_{k} - ( {τ}_{e , k + 1} - {T}_{k + 1} ) )}_{B 2}}_{A 2}\end{matrix} \} + {n}_{O , k} ( t ) & ( 19 ) \\ {{V}_{E , k} ( t )}^{′} = \{ \begin{matrix}{a}_{ k - 1} \cdot g ( {τ}_{e , k} + \frac{{T}_{c}}{2} - ( {T}_{k} - {T}_{k - 1} ) ) - \\ {v}_{O , k - 1} ( t ) \cdot g ( {τ}_{e , k} - {T}_{k} + \frac{{T}_{c}}{2} - ( {τ}_{e , k - 1} - {T}_{k - 1} ) )\end{matrix} \} + {a}_{k} \cdot g ( {τ}_{e , k} + \frac{{T}_{c}}{2} ) + \{ \begin{matrix}{a}_{ k + 1} \cdot g ( {τ}_{e , k} + \frac{{T}_{c}}{2} - ( {T}_{k} - {T}_{k - 1} ) ) - \\ {v}_{O , k + 1} ( t ) \cdot g ( {τ}_{e , k} - {T}_{k} + \frac{{T}_{c}}{2} - ( {τ}_{e , k + 1} - {T}_{k + 1} ) )\end{matrix} \} + {n}_{E , k} ( t ) & ( 20 ) \\ {{V}_{L , k} ( t )}^{′} = \{ \begin{matrix}{a}_{ k - 1} \cdot g ( {τ}_{e , k = 1} - \frac{{T}_{c}}{2} - ( {T}_{k} - {T}_{k - 1} ) ) - \\ {v}_{O , k - 1} ( t ) \cdot g ( {τ}_{e , k} - {T}_{k} - \frac{{T}_{c}}{2} - ( {τ}_{e , k - 1} - {T}_{k - 1} ) )\end{matrix} \} + {a}_{k} \cdot g ( {τ}_{e , k = 1} - \frac{{T}_{c}}{2} ) + \{ \begin{matrix}{a}_{ k + 1} \cdot g ( {τ}_{e , k = 1} - \frac{{T}_{c}}{2} - ( {T}_{k} - {T}_{k - 1} ) ) - \\ {v}_{O , k = 2} ( t ) \cdot g ( {τ}_{e , k} - {T}_{k} - \frac{{T}_{c}}{2} - ( {τ}_{e , k + 1} - {T}_{k + 1} ) )\end{matrix} \} + {n}_{L , k} ( t ) & ( 21 )\end{matrix}$$

FIG. 2 shows Equations (19), (20), and (21). In Equation (19), the “B1” part corresponds to an input value of the first multiplier 207, and the “B2” part corresponds to an input value of the second multiplier 209. Further, the “A1” part and the “A2” part of Equation (19) correspond to output values of the first multiplier 207 and value by the integral period and an output value of the delayer 210 is transferred to a code tracking loop of an adjacent path.

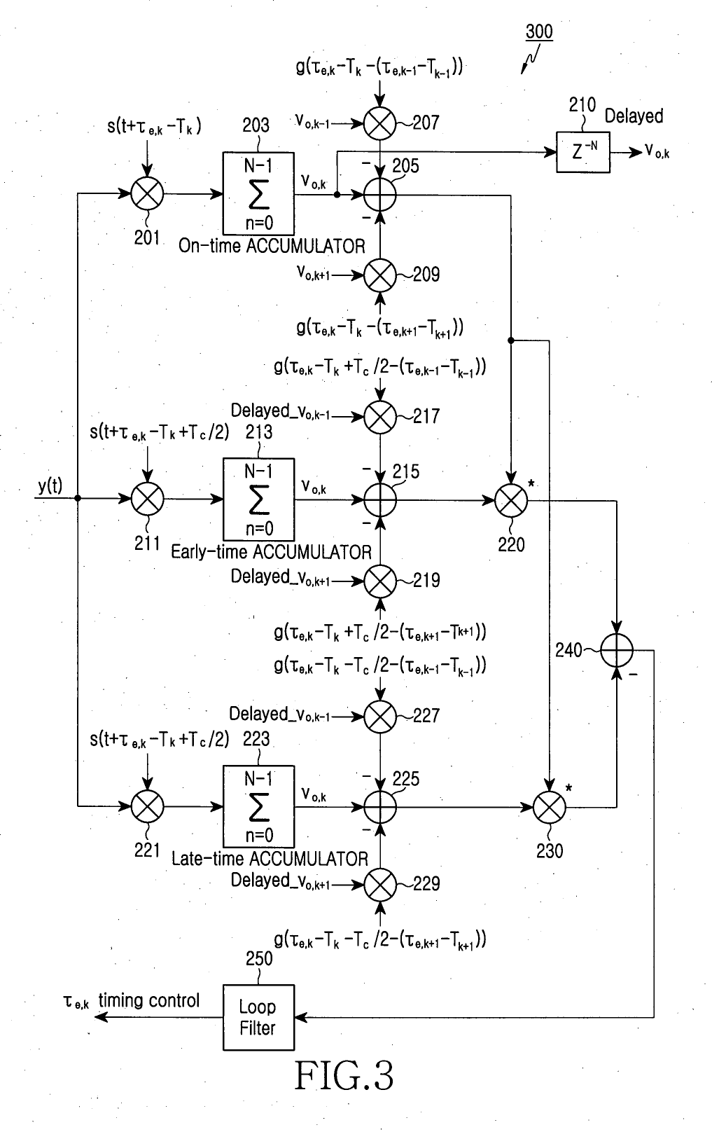

FIG. 3 shows another example of a code tracking loop apparatus according to the present invention that uses on-time integral values of two adjacent paths in calculating the interference-eliminated on-time signal, and uses delayed on-time integral values of two adjacent paths in calculating the interference-eliminated early-time and late-time signals.

Referring to FIG. 3, similarly to use of an on-time integral value of a delayed adjacent path in order to eliminate an adjacent path element from an on-time integral value according to the example shown in FIG. 2, an on-time integral value of a delayed adjacent path is also used in order to eliminate an interference element for the adjacent path from the early-time and late-time integral values. To this end, un-delayed on-time integral values ν_{O,k+1} and ν_{O,k+1} are input to the first multiplier 207 and the second multiplier 209, respectively, and on-time integral values Delayed_ν_{O,k-1}(t) and Delayed_ν_{O,k+1}(t) of delayed adjacent paths are input to the other multiplier multipliers 217, 219, 227, and 229, respectively.

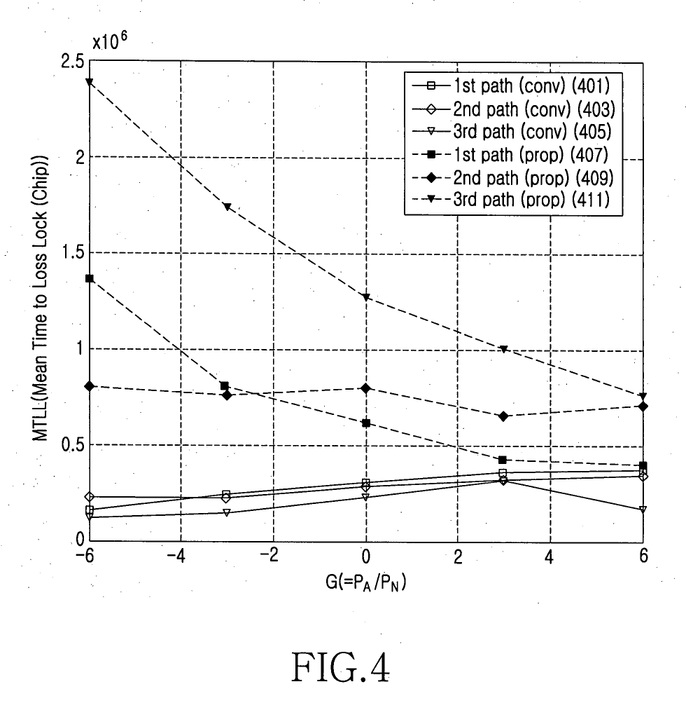

FIG. 4 shows a graph illustrating comparison between the capability of a conventional code tracking loop and a code tracking loop according to the present invention. An experiment has been tested in a multi-path environment having three paths (L=3). In the multi-path environment, the three paths have power of −3 dB, −6 dB, and −6 dB and delay values of 0, 1 chip, and 2 chips, respectively. P_{A} refers to the entire transmission power of a base station, wherein a channel used for the code tracking loop occupies 1/10 of the entire transmission power. Further, P_{N} refers to a noise power. Mean Time to Lose Lock (MTLL) has been used in order to compare the two schemes, and the point at which the lock is released is defined as a time point at which one path joins an adjacent path.

Referring to FIG. 4, it is noted that, in the case of the MTLL for the first path 401, the methods according to the present invention have a higher MTLL value than the conventional methods with various signal to noise ratios. The higher MTLL implies the conventional methods with various signal to noise ratios. The higher MTLL implies that the path allocated to the code tracking part is less influenced by adjacent paths and can maintain the allocated path for long time. The method of the present invention can achieve a capability of the same inclination for another path also. That is, the method of the present invention has longer average time for movement from a path to another path than the conventional methods. As described above, it is necessary to demodulate data of various paths in order to raise the reception capability in a CDMA system. The method of the present invention guarantees a higher capability than the conventional methods, because the method of the present invention can maintain an allocated path for longer time than the conventional methods.

According to the present invention as described above, an interference-eliminated on-time integral value is used in order to improve the capability of a non-coherent code tracking loop applying interference-eliminating technology, and an on-time integral value of a delayed adjacent path is used in eliminating the interference. Therefore, the present invention can achieve more exact calibration of time error for each path in a multi-path environment having small time difference between paths, thereby improving the reception capability of a direct sequence code division multiple access communication system.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A code tracking loop apparatus in a rake receiver for calibrating a time error of each path by receiving a multi-layer signal in a Code Division Multiple Access (CDMA) system, the code tracking loop apparatus comprising:
an on-time signal block for outputting a first signal, the first signal obtained by eliminating an interference signal of an adjacent path from an on-time integral value for a received signal of a predetermined path;
an early-time signal block for eliminating an interference signal of an adjacent path from an early-time integral value for the received signal of the predetermined path, and multiplying the interference-eliminated signal by a conjugate complex of the first signal;
a late-time signal block for eliminating an interference signal of an adjacent path from a late-time integral value for the received signal of the predetermined path, and multiplying the interference-eliminated signal by a conjugate complex of the first signal; and
a first subtractor for calculating a difference between an output of the early-time signal block and an output of the late-time signal block.

2. The code tracking loop apparatus as claimed in claim 1, wherein the on-time signal block comprises:
an on-time accumulator for multiplying the received signal by an on-time signal and accumulating products of the multiplication by a predetermined integral period, thereby outputting an on-time integral value;
a first multiplier for multiplying a delayed on-time integral value of a previous path by a pulse-shaping filter coefficient corresponding to a timing difference between the previous path and the on-time signal;
a second multiplier for multiplying a delayed on-time integral value of a next path by a pulse-shaping filter coefficient corresponding to a timing difference between the next path and the on-time signal; and
a second subtractor for subtracting output signals of the first and second multipliers from the on-time integral value of the on-time accumulator.

3. The code tracking loop apparatus as claimed in claim 1, wherein the early-time signal block comprises:
an early-time accumulator for multiplying the received signal by an early-time signal and accumulating products of the multiplication by a predetermined integral period, thereby outputting an early-time integral value;
a first multiplier for multiplying an on-time integral value of a previous path by a pulse-shaping filter coefficient corresponding to a timing difference between the previous path and the early-time signal;
a second multiplier for multiplying an on-time integral value of a next path by a pulse-shaping filter coefficient corresponding to a timing difference between the next path and the early-time signal; and
a second subtractor for subtracting output signals of the first and second multipliers from the early-time integral value of the early-time accumulator.

4. The code tracking loop apparatus as claimed in claim 1, wherein the late-time signal block comprises:
a late-time accumulator for multiplying the received signal by a late-time signal and accumulating products of the multiplication by a predetermined integral period, thereby outputting a late-time integral value;
a first multiplier for multiplying an on-time integral value of a previous path by a pulse-shaping filter coefficient corresponding to a timing difference between the previous path and the late-time signal;
a second multiplier for multiplying an on-time integral value of a next path by a pulse-shaping filter coefficient corresponding to a timing difference between the next path and the late-time signal; and
a second subtractor for subtracting output signals of the first and second multipliers from the late-time integral value of the late-time accumulator.

5. The code tracking loop apparatus as claimed in claim 1, wherein the on-time signal block comprises:
an on-time accumulator for multiplying the received signal by an on-time signal and accumulating products of the multiplication by a predetermined integral period, thereby outputting an on-time integral value;
a first multiplier for multiplying an on-time integral value of a previous path by a pulse-shaping filter coefficient corresponding to a timing difference between the previous path and the on-time signal;
a second multiplier for multiplying an on-time integral value of a next path by a pulse-shaping filter coefficient corresponding to a timing difference between the next path and the on-time signal; and
a second subtractor for subtracting output signals of the first and second multipliers from the on-time integral value of the on-time accumulator.

6. The code tracking loop apparatus as claimed in claim 1, wherein the early-time signal block comprises:
an early-time accumulator for multiplying the received signal by an early-time signal and accumulating products of the multiplication by a predetermined integral period, thereby outputting an early-time integral value;
a first multiplier for multiplying a delayed on-time integral value of a previous path by a pulse-shaping filter coefficient corresponding to a timing difference between the previous path and the early-time signal;
a second multiplier for multiplying a delayed on-time integral value of a next path by a pulse-shaping filter coefficient corresponding to a timing difference between the next path and the early-time signal; and
a second subtractor for subtracting output signals of the first and second multipliers from the early-time integral value of the early-time accumulator.

7. The code tracking loop apparatus as claimed in claim 1, wherein the late-time signal block comprises:
a late-time accumulator for multiplying the received signal by a late-time signal and accumulating products of the multiplication by a predetermined integral period, thereby outputting a late-time integral value;
a first multiplier for multiplying a delayed on-time integral value of a previous path by a pulse-shaping filter coefficient corresponding to a timing difference between the previous path and the late-time signal;
a second multiplier for multiplying a delayed on-time integral value of a next path by a pulse-shaping filter coefficient corresponding to a timing difference between the next path and the late-time signal; and
a second subtractor for subtracting output signals of the first and second multipliers from the late-time integral value of the late-time accumulator.

8. A code tracking loop method in a rake receiver for calibrating a time error of each path by receiving a multi-layer signal in a Code Division Multiple Access (CDMA) system, the code tracking loop method comprising the steps of:
(1) outputting a first signal, a second signal, and a third signal by eliminating an interference signal of an adjacent path from integral values of an on-time signal, an early-time signal, and a late-time signal for a received signal of a predetermined path, respectively;
(2) multiplying the second signal and the third signal by a conjugate complex of the first signal; and
(3) calculating a difference between a conjugate complex of the first signal and the multiplied signal.

9. The code tracking loop method as claimed in claim 8, wherein the step of outputting the first signal comprises:
multiplying the received signal by an on-time signal and accumulating products of the multiplication by a predetermined integral period, thereby outputting an on-time integral value;
multiplying a delayed on-time integral value of a previous path by a pulse-shaping filter coefficient corresponding to a timing difference between the previous path and the on-time signal, thereby generating an interference signal;
multiplying a delayed on-time integral value of a next path by a pulse-shaping filter coefficient corresponding to a timing difference between the next path and the on-time signal, thereby generating an interference signal; and
subtracting the interference signals from the on-time integral value.

10. The code tracking loop method as claimed in claim 8, wherein the step of outputting the second signal comprises:
multiplying the received signal by an early-time signal and accumulating products of the multiplication by a predetermined integral period, thereby outputting an early-time integral value;
multiplying an on-time integral value of a previous path by a pulse-shaping filter coefficient corresponding to a timing difference between the previous path and the early-time signal, thereby generating an interference signal;
multiplying an on-time integral value of a next path by a pulse-shaping filter coefficient corresponding to a timing difference between the next path and the early-time signal, thereby generating an interference signal; and
subtracting the interference signals from the early-time integral value.

11. The code tracking loop method as claimed in claim 8, wherein the step of outputting the third signal comprises:
multiplying the received signal by a late-time signal and accumulating products of the multiplication by a predetermined integral period, thereby outputting a late-time integral value;
multiplying an on-time integral value of a previous path by a pulse-shaping filter coefficient corresponding to a timing difference between the previous path and the late-time signal, thereby generating an interference signal;
multiplying an on-time integral value of a next path by a pulse-shaping filter coefficient corresponding to a timing difference between the next path and the late-time signal, thereby generating an interference signal; and
subtracting the interference signals from the late-time integral value.

12. The code tracking loop method as claimed in claim 8, wherein the step of outputting the first signal comprises:
multiplying the received signal by an on-time signal and accumulating products of the multiplication by a predetermined integral period, thereby outputting an on-time integral value;
multiplying an on-time integral value of a previous path by a pulse-shaping filter coefficient corresponding to a timing difference between the previous path and the on-time signal, thereby generating an interference signal;
multiplying an on-time integral value of a next path by a pulse-shaping filter coefficient corresponding to a timing difference between the next path and the on-time signal, thereby generating an interference signal; and
subtracting the interference signals from the on-time integral value.

13. The code tracking loop method as claimed in claim 8, wherein the step of outputting the second signal comprises:
multiplying the received signal by an early-time signal and accumulating products of the multiplication by a predetermined integral period, thereby outputting an early-time integral value;
multiplying a delayed on-time integral value of a previous path by a pulse-shaping filter coefficient corresponding to a timing difference between the previous path and the early-time signal, thereby generating an interference signal;
multiplying a delayed on-time integral value of a next path by a pulse-shaping filter coefficient corresponding to a timing difference between the next path and the early-time signal, thereby generating an interference signal; and
subtracting the interference signals from the early-time integral value.

14. The code tracking loop method as claimed in claim 8, wherein the step of outputting the third signal comprises:
multiplying the received signal by a late-time signal and accumulating products of the multiplication by a predetermined integral period, thereby outputting a late-time integral value;
multiplying a delayed on-time integral value of a previous path by a pulse-shaping filter coefficient corresponding to a timing difference between the previous path and the late-time signal, thereby generating an interference signal;
multiplying a delayed on-time integral value of a next path by a pulse-shaping filter coefficient corresponding to a timing difference between the next path and the late-time signal, thereby generating an interference signal; and
subtracting the interference signals from the late-time integral value.
